(19) United States
(12) Patent Application Publication
(10) Pub. No.: US 2026/0004154 A1
(43) Pub. Date: Jan. 1, 2026

(54) MACHINE LEARNING-BASED PCIe BIFURCATION CONFIGURATION

(71) Applicant: Aivres Systems Inc., San Jose, CA (US)

(72) Inventor: Yatzu HUANG, New Taipei City (TW)

(21) Appl. No.: 19/317,779

(22) Filed: Sep. 3, 2025

(51) Int. Cl. G06N 5/01; G06F 21/64

(52) U.S. Cl. CPC G06N 5/01; G06F 21/64

(57) ABSTRACT

A dynamic method and system for configuring PCI Express (PCIe) bifurcation is provided. A baseboard management controller (BMC) receives system condition data representing current hardware configuration and operational metrics, including device presence, negotiated link widths, error counts, and thermal events. A trained machine learning model, such as a decision tree, predicts boot success outcomes for multiple candidate bifurcation configurations. The BMC selects a preferred configuration based on the predictions and writes it to a reserved memory buffer (RMB). During subsequent initialization, a basic input/output system (BIOS) retrieves the preferred configuration from the RMB and applies it to initialize PCIe links. The model is periodically retrained with new boot outcomes to refine predictions, enabling adaptive, self-learning bifurcation without repeated BIOS recompilation or reflashing.

### TECHNICAL FIELD

The present disclosure relates generally to computer system initialization and configuration, and more particularly to methods, systems, and computer-readable media for dynamically determining and applying Peripheral Component Interconnect Express (PCIe) bifurcation settings in a computing system using machine learning models executed on a baseboard management controller (BMC).

### BACKGROUND

In conventional server and motherboard platforms, PCI Express (PCIe) bifurcation refers to the setting that determines how physical PCIe lanes are divided among multiple downstream ports. For instance, a x16 PCIe link from a CPU may be split into x8/x8, x4/x4/x8, or other lane combinations to accommodate various add-in cards such as GPUs, network interface controllers, or storage devices. Traditionally, these bifurcation settings are pre-encoded into BIOS firmware during system design. The selection logic is static, relying on fixed hardware indicators such as Board ID, SKU (Stock Keeping Unit), or GPIO (General-Purpose Input/Output) pin states, with the relevant tables hardcoded into firmware modules and applied during early system initialization.

Although this approach provides stability, it presents significant drawbacks. Any adjustment to a configuration requires source code modification, recompilation, and reflashing of the BIOS, which is both time-consuming and inflexible. Supporting multiple hardware variants demands the maintenance of numerous pre-compiled tables, leading to higher development costs and extended testing cycles. More critically, such systems lack intelligence or adaptability: they cannot use operational data, such as link training logs, boot failure histories, or thermal conditions, to optimize configurations or avoid repeated failures. The reliance on rigid hardware-coupled control flow also makes remote management and runtime adjustments difficult, while BIOS reflashing carries inherent risks that can disrupt system availability.

The absence of intelligent, data-driven bifurcation control prevents existing systems from adapting configurations to actual runtime hardware conditions, optimizing strategies based on observed error or performance trends, or safely enabling updates without BIOS modification. As a result, current approaches fall short of the needs of modern high-availability platforms, where flexibility, automation, and data-informed decision-making are increasingly critical for ensuring system stability, deployment efficiency, and effective remote manageability.

### SUMMARY

A system of one or more computers can be configured to perform particular operations by installing software, firmware, hardware, or any combination thereof that, in operation, causes the system to perform those operations. Likewise, one or more computer programs can be configured to perform particular operations by including instructions that, when executed by data-processing apparatus, cause the apparatus to perform the operations.

In one general aspect, a computer-implemented method includes receiving, by a baseboard management controller (BMC), system-condition data representing the current hardware configuration and operational metrics of a computing system. The method also includes generating, by a trained machine-learning model executed on the BMC, a prediction of boot-success outcome for each of a plurality of candidate PCIe bifurcation configurations based on the system-condition data. The method further includes selecting, by the BMC, a preferred PCIe bifurcation configuration from the plurality of candidates based at least on the predicted boot-success outcomes, and writing the preferred configuration to a reserved memory buffer (RMB) accessible to the basic input/output system (BIOS) of the computing system. the BIOS parses and validates the preferred PCIe bifurcation configuration and stores the preferred PCIe bifurcation configuration in a non-volatile memory region. During a subsequent initialization of the computing system, the BIOS retrieves the preferred configuration from the from the non-volatile memory region (e.g., a ROM hole) and applies it to initialize the system's PCIe links. Other embodiments of this aspect include corresponding computer systems, apparatus, and computer programs recorded on one or more computer-storage devices, each configured to perform the actions of the methods.

Implementations may include one or more of the following features. The system-condition data can include at least one of: PCIe device presence or type in individual slots; negotiated link width; error metrics including counts of Advanced Error Reporting (AER) errors or cyclic redundancy check (CRC) errors; thermal measurements; detection of threshold violations; slot-usage frequency or hot-plug events; and boot outcomes recorded across prior initialization cycles. The method can include training the machine-learning model by collecting or receiving historical system-condition data from multiple prior boot attempts (e.g., PCIe logs, negotiated link widths, link-training logs, error records, and boot outcomes), transforming the historical data into feature vectors with associated outcome labels, and training the model based on the feature vectors and labels to correlate the historical data with boot-success outcomes for the plurality of candidate PCIe bifurcation configurations. In some implementations the machine-learning model includes a decision tree, and training includes applying the feature vectors to the tree so that it partitions the feature space using a Gini-impurity criterion to identify one or more feature splits most correlated with the boot outcomes; the trained tree is stored in the BMC for use during inference. The method can further include periodically retraining the model by appending, after one or more boot attempts, new system-condition data—such as slot occupancy, negotiated link widths, error records, thermal measurements, and boot outcome—to a training dataset maintained by the BMC to obtain an augmented dataset, and recomputing decision thresholds or changing one or more feature splits based on the augmented dataset. Storing the preferred PCIe bifurcation configuration in the RMB can include writing the configuration to a bifurcation table with checksum data for integrity validation. When the trained model is a decision tree, generating the prediction of boot-success outcome can include applying current system-condition feature vectors to the tree, traversing feature splits previously determined during training using the Gini-impurity criterion, and outputting, based on the reached leaf nodes, predicted boot-success outcomes for the candidate configurations corresponding to the current feature vectors. Receiving the system-condition data can include detecting a trigger event—such as insertion or removal of a PCIe device, rising PCIe error rates, or exceeding a thermal threshold—and collecting the system-condition data in response to the trigger. The method can also include writing the preferred configuration into a non-volatile memory region accessible across power cycles, and ranking the candidate PCIe bifurcation configurations by their corresponding predicted boot-success outcomes and storing the ranked list in the RMB. In some implementations the machine-learning model is configured to generate new entries when a previously unseen hardware combination is detected. The described techniques may be implemented in hardware, as a method or process, or on a tangible computer-readable medium.

In another general aspect, a computing system includes a BMC configured to collect system-condition data indicative of current hardware configuration and operational metrics; execute a machine-learning model trained to predict boot outcomes for different PCIe bifurcation configurations; determine, based on the predicted outcomes, a preferred PCIe bifurcation configuration; and store the preferred configuration in an RMB. The computing system also includes a BIOS configured to access the RMB during initialization of the computing system and to apply the preferred PCIe bifurcation configuration to initialize PCIe links. Other embodiments of this aspect include corresponding computer systems, apparatus, and computer programs recorded on one or more computer-storage devices, each configured to perform the actions of the methods.

Implementations may include one or more of the following features. The system-condition data can include at least one of: PCIe device presence or type in individual slots; negotiated link width; error metrics including counts of AER errors or CRC errors; thermal measurements; detection of threshold violations; slot-usage frequency or hot-plug events; and historical boot outcomes recorded across prior initialization cycles. When the machine-learning model includes a decision tree, the BMC can apply current system-condition feature vectors as inputs to the tree, traverse previously learned feature splits identified during training using a Gini-impurity criterion, and output, based on the reached leaf nodes, predicted boot-success outcomes for a plurality of candidate PCIe bifurcation configurations for the current feature vectors. In some implementations the model is configured to generate new entries when a hardware combination not previously observed is detected. The described techniques may be implemented in hardware, as a method or process, or on a tangible computer-readable medium.

In a further aspect, a non-transitory computer-readable storage medium stores instructions that, when executed, cause a device to perform operations including receiving system-condition data from a plurality of PCIe slots; applying the data to a trained machine-learning model to obtain predicted boot outcomes for a plurality of candidate PCIe bifurcation configurations; selecting a preferred configuration based on the predicted outcomes; and storing the preferred configuration in an RMB accessible to a BIOS for use in PCIe initialization. Other embodiments of this aspect include corresponding computer systems, apparatus, and computer programs recorded on one or more computer-storage devices, each configured to perform the actions of the methods.

Implementations may include one or more of the following features. The system-condition data can include at least one of: PCIe device presence or type in individual slots; negotiated link width; error metrics including counts of AER errors or CRC errors; thermal measurements; detection of threshold violations; slot-usage frequency or hot-plug events; and historical boot outcomes recorded across prior initialization cycles. When the trained model is a decision tree, generating the prediction of boot-success outcome can include applying current system-condition feature vectors to the tree, traversing feature splits previously determined during training using a Gini-impurity criterion, and outputting, based on the reached leaf nodes, the predicted boot-success outcomes for the candidate configurations corresponding to the current feature vectors. Receiving the system-condition data can include detecting a trigger event-such as insertion or removal of a PCIe device, rising PCIe error rates, or exceeding a thermal threshold-and collecting the system-condition data in response to the trigger. The operations can further include training the model by collecting or receiving historical system-condition data from prior boot attempts (including PCIe logs, negotiated link widths, link-training logs, error records, and boot outcomes), transforming the historical data into feature vectors with associated outcome labels, and training the model to correlate the historical data with boot-success outcomes for the candidate PCIe bifurcation configurations. The described techniques may be implemented in hardware, as a method or process, or on a tangible computer-readable medium.

### BRIEF DESCRIPTION OF THE DRAWINGS

Certain features of various embodiments of the present technology are set forth with particularity in the appended claims. A better understanding of the features and advantages of the technology will be obtained by reference to the following detailed description that sets forth illustrative embodiments, in which the principles of the disclosure are utilized, and the accompanying drawings of which:

FIG. 1 illustrates an example system architecture for dynamically configuring PCIe bifurcation settings, according to one example embodiment.

FIG. 2 illustrates an example flow chart for dynamically configuring PCIe bifurcation settings, according to one example embodiment.

FIG. 3 illustrates an example training process of the machine learning model used to predict PCIe bifurcation outcomes, according to one example embodiment.

FIG. 4A illustrates an example feature split of a decision tree for predicting PCIe bifurcation outcomes, according to one example embodiment.

FIG. 4B illustrates another example feature split of a decision tree for predicting PCIe bifurcation outcomes, according to one example embodiment.

FIG. 5 illustrates an example inferencing phase of the machine learning model used to predict PCIe bifurcation outcomes, according to one example embodiment.

FIG. 6A illustrates an example inference result table generated by the machine learning model on the BMC, according to one example embodiment.

FIG. 6B illustrates an example data structure of a bifurcation configuration table stored in a reserved memory buffer (RMB), according to one example embodiment.

FIG. 7 illustrates an example method of machine learning-based PCIe bifurcation configuration, according to one example embodiment.

FIG. 8 illustrates a block diagram of an example computer system in which various of the embodiments described herein may be implemented.

### DETAILED DESCRIPTION OF EMBODIMENTS

In the following description, certain specific details are set forth in order to provide a thorough understanding of various embodiments of the disclosure. However, one skilled in the art will understand that the disclosure may be practiced without these details. Moreover, while various embodiments of the disclosure are disclosed herein, many adaptations and modifications may be made within the scope of the disclosure in accordance with the common general knowledge of those skilled in this art. Such modifications include the substitution of known equivalents for any aspect of the disclosure in order to achieve the same result in substantially the same way.

Unless the context requires otherwise, throughout the present specification and claims, the word “comprise” and variations thereof, such as, “comprises” and “comprising” are to be construed in an open, inclusive sense, that is as “including, but not limited to.” Recitation of numeric ranges of values throughout the specification is intended to serve as a shorthand notation of referring individually to each separate value falling within the range inclusive of the values defining the range, and each separate value is incorporated in the specification as it were individually recited herein. Additionally, the singular forms “a,” “an” and “the” include plural referents unless the context clearly dictates otherwise.

Reference throughout this specification to “one embodiment” or “an embodiment” means that a particular feature, structure or characteristic described in connection with the embodiment is included in at least one embodiment of the present disclosure. Thus, the appearances of the phrases “in one embodiment” or “in an embodiment” in various places throughout this specification are not necessarily all referring to the same embodiment, but may be in some instances. Furthermore, the particular features, structures, or characteristics may be combined in any suitable manner in one or more embodiments.

In order to better understand the embodiments described herein, the key components relevant to dynamic PCIe bifurcation are briefly introduced.

A computing system typically includes a processor and a set of Peripheral Component Interconnect Express (PCIe) slots for accommodating add-in devices such as graphics processing units (GPUs), network interface controllers (NICs), or storage controllers. Each PCIe slot is assigned one or more PCIe lanes, which are point-to-point high-speed serial links.

PCIe bifurcation refers to dividing a set of lanes from the CPU or chipset into multiple downstream ports. For example, sixteen (x16) PCIe lanes may be allocated entirely to a single x16 slot, or split into two x8 slots, or other lane combinations. Proper bifurcation is critical because devices expect certain link widths, and misalignment between device expectations and bifurcation configuration can result in degraded performance, link training failures, or complete boot failure.

As explained in the background section, bifurcation settings are conventionally defined statically in the basic input/output system (BIOS) firmware through predefined tables. These static configurations cannot adapt to changing hardware combinations or operational conditions. Updating the settings requires recompilation and reflashing of the BIOS, which is risky and operationally expensive.

A baseboard management controller (BMC) provides an out-of-band management processor that can monitor hardware conditions, collect logs, and perform configuration tasks independently of the host CPU and operating system. In this disclosure, the BMC is leveraged to execute a machine learning model that dynamically predicts optimal PCIe bifurcation configurations based on system condition data, such as device presence, error rates, or thermal events.

A reserved memory buffer (RMB) on the computing device (e.g., a server) serves as a shared memory region accessible to both the BMC and the BIOS. The BMC writes its predicted bifurcation configuration into the RMB, and during initialization the BIOS retrieves the configuration and applies it to the PCIe slots. This dynamic PCIe bifurcation enables intelligent, data-driven adjustment of lane allocations that reduce boot failures and improve system stability, without requiring BIOS reflashing or manual intervention.

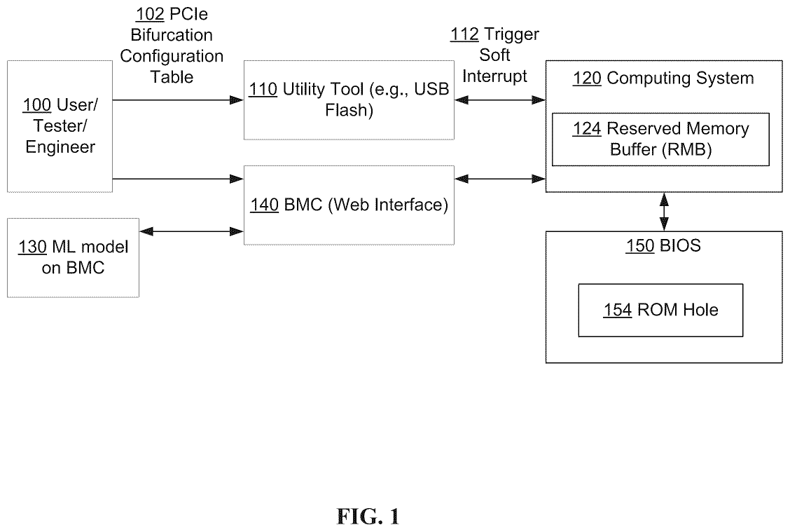

FIG. 1 illustrates an example system architecture for dynamically configuring PCIe bifurcation settings without reflashing firmware, according to one example embodiment.

As shown in FIG. 1, the PCIe bifurcation configuration table 102 refers to a BIOS-readable data structure that encodes, for each relevant PCIe root port or slot of the computing system 120, the lane-split arrangement to be applied during initialization (for example, whether a given x16 link remains x16 or is split into x8/x8 or x4/x4/x8). The PCIc bifurcation configuration table 102 is designed to be dynamically maintained: it is updated as system conditions change and as a trained machine-learning model 130 running on a baseboard management controller (BMC) 140 produces new predictions of boot success outcomes for candidate bifurcation configurations. In some embodiments, the PCIe bifurcation configuration table 102 is written into a reserved memory buffer (RMB) 124 for staging, and once validated the BIOS 150 persists a copy in a “ROM hole” 154, a non-volatile region within BIOS flash so the configuration survives power cycles and is applied at the next boot.

In some embodiments, the PCIe bifurcation configuration table 102 may include a header signature, a version field, a total-slot count, one or more per-slot or per-root-port bifurcation mode fields, and a checksum (for example, an XOR over the table bytes) that the BIOS verifies prior to use. Implementations may also carry metadata such as a timestamp, a validity flag, per-configuration confidence scores, and an optional ranked list of candidate configurations associated with the current system state. Note that the PCIe bifurcation configuration table 102 is not the ML model 130 itself; it is the materialized result of the current preferred PCIe bifurcation configuration that the BIOS will apply during a subsequent initialization of the computing system 120. The ML model 130 is trained and deployed to generate entries (e.g., an optimal PCIe bifurcation configuration for a current system condition), which will be used to expand or update the PCIe bifurcation configuration table 102.

There may be multiple ways to obtain and maintain the PCIe bifurcation configuration table 102. In a first embodiment, a user, tester, or engineer 100 supplies a baseline version of the PCIe bifurcation configuration table 102 via a utility tool 110 (for example, a USB flash tool). The submission triggers a soft interrupt 112 on the computing system 120, which causes the PCIe bifurcation configuration table 102 to be written into the reserved memory buffer (RMB) 124 in a BIOS-readable format. Afterward, the PCIe bifurcation configuration table 102 is maintained and updated by the BMC 140 using a trained machine-learning (ML) model 130 that evaluates current system condition data and predicted boot-success outcomes for candidate configurations. In an alternative embodiment, the user, tester, or engineer 100 provides the PCIe bifurcation configuration table 102 through a web interface exposed by the BMC 140; the BMC 140 then writes the PCIe bifurcation configuration table 102 into the RMB 124 and thereafter continuously updates and maintains it using the ML model 130.

For example, during inference, the ML model 130 executes on the BMC and consumes system condition data representing the current hardware configuration and operational metrics—including PCIe device presence or type in individual slots, negotiated link widths, error metrics such as Advanced Error Reporting (AER) and cyclic redundancy check (CRC) counts, thermal measurements and threshold-violation events, slot-usage frequency and hot-plug events, and historical boot outcomes—to generate predicted boot success outcomes for a plurality of candidate PCIe bifurcation configurations. Based at least on those predictions, the BMC 140 selects the preferred configuration (maybe more than one) for the present state and updates the PCIe bifurcation configuration table 102 accordingly, optionally annotating confidence scores and a ranked list of candidates.

In a second embodiment, no baseline of the PCIe bifurcation configuration table 102 is provided from the user/tester/engineer 100; the BMC 140 trains the machine-learning model 130 using historical system condition data (e.g., PCIe logs, negotiated link widths and link-training records, AER/CRC error statistics, thermal events and threshold violations, slot-usage and hot-plug history, and prior boot outcomes) by transforming such data into feature vectors with outcome labels so the model learns, for known system conditions, the candidate PCIe bifurcation configurations and their associated predicted boot-success outcomes. After training, the BMC 140 infers a preferred configuration for the current system condition by applying the trained model 130 to generate predicted boot-success outcomes for a plurality of candidate configurations, selecting the preferred configuration based at least on those predictions, and materializing the BIOS-readable PCIe bifurcation configuration table 102 that the BMC writes into the RMB 124. Over time, the BMC continuously maintains and refreshes the PCIe bifurcation configuration table 102 by appending newly observed system condition data and boot logs, retraining or refining the model 130 as needed, generating new entries for hardware combinations not previously observed, revising existing entries when observed outcomes deviate from prior predictions, and updating the RMB 124 with the most recent preferred configuration (optionally with confidence scores and rankings) for application by the BIOS at subsequent initialization.

In some embodiments, updates to the PCIe bifurcation configuration table 102 are initiated automatically or on demand. When the BMC 140 detects a change in system conditions (such as insertion or removal of a PCIe device, a rise in AER/CRC error rates, or a thermal-threshold breach), or upon an administrative request via the BMC interface, the BMC 140 invokes the ML model 130 to perform inference for the current system condition, generate predicted boot-success outcomes for a plurality of candidate PCIe bifurcation configurations, select one or more preferred configurations (in some cases, with corresponding confidence scores), and materialize updated table contents in 102. The BMC 140 then writes the updated PCIe bifurcation configuration table 102 into the RMB 124 as the staging area; where applicable, the update may include new entries created for previously unseen hardware combinations, updated entries created for existing hardware combinations, optional confidence scores and rankings associated with candidate configurations.

In some embodiments, when an update to the PCIe bifurcation configuration table 102 is detected, the BIOS 150 may parse (e.g., by invoking a software-interrupt handler, such as an SMI routine) and validate the table by checking the header signature and version, verifying the checksum, confirming slot cardinality, and ensuring internal consistency of the per-slot modes. If validation succeeds, the BIOS 150 commits the updated table 102 to a non-volatile region (e.g., the ROM hole 154) so that the updated table 102 persists across power cycles. During a subsequent initialization of the computing system 120, the BIOS 150 retrieves the validated table from the ROM hole 154 and applies the encoded bifurcation settings to initialize the PCIe links. Application occurs at initialization rather than during live operation; if validation fails or no new table is present, the BIOS 150 reuses the last known-good configuration stored in the ROM hole 154 to preserve bootability.

In some embodiments, BIOS 150 retrieval and persistence of the PCIe bifurcation configuration table 102 is performed incrementally to reduce migration bandwidth and flash wear. The BMC 140 writes, into the RMB 124, a delta block that identifies only the changed or added entries—e.g., via per-slot offsets, a change bitmap, or a small journal—together with a table version or epoch, a delta-length field, and a delta checksum. Upon detecting the update, the BIOS 150 validates the delta (signature, length, checksum, and version continuity), reads just the modified fields from the RMB 124, and applies them in place to the copy of the table persisted in the ROM hole 154 (a non-volatile memory region accessible across power cycles), then recomputes and stores an updated global checksum and version for the full table. Optionally, atomicity may be ensured by writing to a shadow region of the ROM hole 154 and flipping a commit flag, or by bracketing the update with begin/end markers; deletions may be represented as tombstones in the delta. If the delta fails validation, indicates a version gap, or targets an unknown layout, the BIOS 150 falls back to a full-table refresh from the RMB 124 or retains the last known-good table already stored in the ROM hole 154.

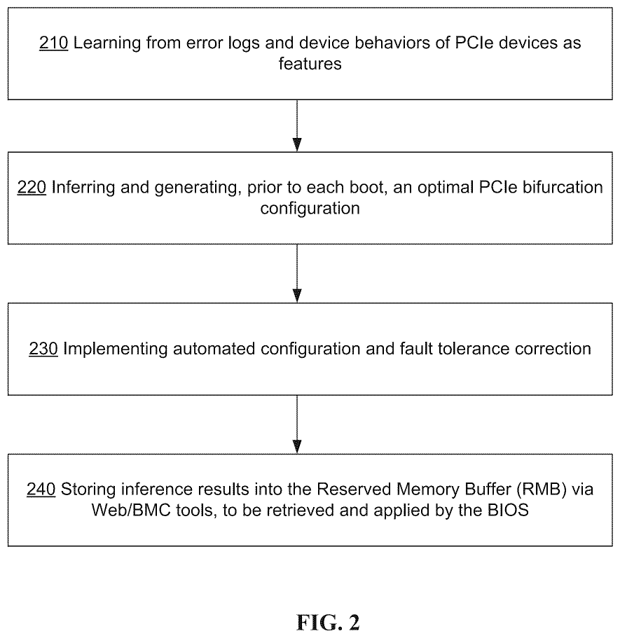

FIG. 2 illustrates an example flow chart for dynamically configuring PCIe bifurcation settings, according to one example embodiment. As shown, the example flow begins at step 210 with learning from error logs and device behaviors of PCIe devices as features. In some embodiments, the BMC continuously captures or receives system condition data that reflects the current hardware configuration and operational metrics of the computing system. Here, the “current” may include real-time status data, recent system events that are logged, latest error messages detected, boot outcomes from a prior time window, etc. For example, the system condition data may include device presence or type for individual PCIe slots, negotiated link widths actually trained by each link, error metrics such as Advanced Error Reporting (AER) and cyclic redundancy check (CRC) counts, thermal measurements and detections of threshold violations, slot-usage frequency and hot-plug activity, and boot outcomes recorded across prior initialization cycles. In some embodiments, the BMC may collect this data in response to explicit triggers: detection of a new device insertion or removal event, a rise in error rates, or an over-temperature condition; in other embodiments, the BMC may sample periodically so the model remains current even in the absence of events. The incoming logs may be normalized into the same feature representation used by the trained machine learning model, ensuring that inference operates on well-formed feature vectors aligned with the model's training schema.

At step 220, the BMC applies a trained machine learning (ML) model—such as a decision tree that traverses previously learned feature splits—to the current feature vectors for inferring and generating, prior to the next boot, an optimal PCIe bifurcation configuration. For a plurality of candidate bifurcation configurations (for example, x16/x0, x8/x8, x4/x4/x8), the ML model produces predicted boot-success outcomes or likelihoods specific to the present hardware state. The BMC ranks the candidates using these predictions, selects the preferred configuration for the upcoming initialization, and, where implemented, associates confidence scores and a record of the ranking so that downstream firmware can audit the choice. If confidence is low or if constraints are violated, the BMC may select a conservative fallback identified by policy or by the last known-good configuration.

At step 230, the BMC's selection enables configuration automation because no BIOS reflashing is required; instead, the preferred configuration is staged for firmware consumption (by the BIOS) and will be applied at the next boot. Fault tolerance may also be achieved by recording both the selection and the observed outcome. If a boot attempt fails using the preferred configuration, the failure is captured as new system condition data, appended to the history, and used to adjust model parameters or confidence scores on subsequent runs. The BIOS can also revert to a persisted last known-good configuration when validation fails, thereby preserving bootability and providing a recovery path during adverse conditions.

At step 240, the BMC materializes the preferred PCIe bifurcation configuration (e.g., the inference results) as a BIOS-readable table and writes it into the Reserved Memory Buffer (RMB), e.g., via Web/BMC tools. The table format may include a header signature and version, per-slot bifurcation mode fields and a total-slot count, optional ranking and confidence annotations, and an integrity checksum (for example, an XOR over the table bytes). In some embodiments, the RMB may be updated either directly by the BMC after inference or via an authorized Web/BMC utility, and BIOS monitors the RMB for updates. Upon detecting new contents added to or changed in the table, BIOS may invoke a firmware handler (e.g., via SMI) to parse and validate the table, and, if valid, persists it into a non-volatile region such as a ROM hole. On the next initialization (e.g., boot), BIOS retrieves the validated table and applies the encoded bifurcation settings to initialize the PCIe links. The flow therefore achieves dynamic, data-driven bifurcation that adapts to actual hardware conditions, while applying changes safely at boot and maintaining a robust rollback path.

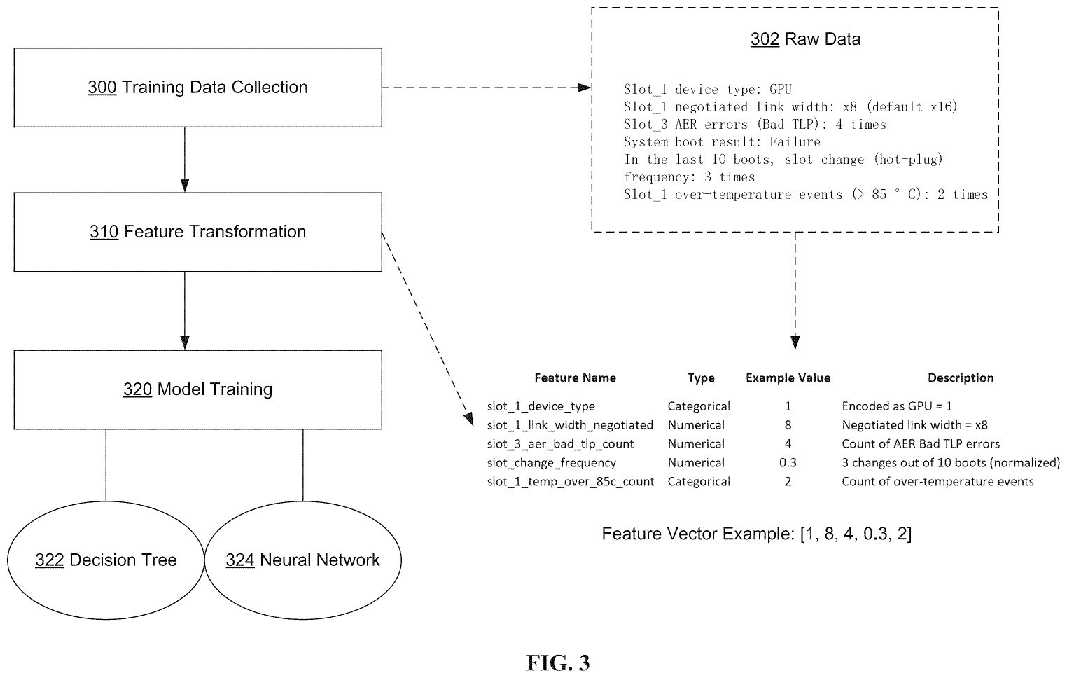

FIG. 3 illustrates an example training process of the machine learning model used to predict PCIe bifurcation outcomes, according to one example embodiment. As shown, the flow may begin with training data collection at step 300, followed by feature transformation at step 310, and model training at step 320. The charts and tables on the right of FIG. 3 provide specific examples of the raw inputs (302) and their corresponding transformed features and feature vector used for ML model training.

In FIG. 3, at step 300, the BMC collects or receives historical system condition data from a plurality of prior boot attempts. The data may include PCIe logs and link-training records, device presence or type per slot, negotiated link widths, AER and CRC error counts, thermal measurements and detections of threshold violations, slot-usage frequency and hot-plug events, and the boot outcome recorded for each attempt. In one specific example, the raw data record 302 is collected as Slot_1 device type=GPU; Slot_1 negotiated link width=x8 (default x16); Slot_3 AER Bad-TLP errors=4 occurrences; system boot result=failure; slot-change (hot-plug) frequency=3 in the last 10 boots; and Slot_1 over-temperature events (>85° C.)=2. Each record in this stage may be paired with an outcome label (e.g., success/failure), forming the basis for supervised learning.

At step 310 the raw system data may be converted into a consistent, machine-readable representation. For example, categorical values such as device type are encoded into numeric symbols; continuous metrics such as negotiated link width, error counts, and thermal/event statistics are preserved or normalized; and frequency-style statistics may be scaled to rates (e.g., 3 changes in 10 boots becomes 0.3). The example table in FIG. 3 shows representative features created from raw inputs: slot_1_device_type encoded as 1 for GPU; slot_1_link_width_negotiated as 8 (for x8); slot_3_aer_bad_tlp_count as 4; slot_change_frequency as 0.3; and slot_1_temp_over_85c_count as 2. These fields are then assembled into a feature vector, illustrated as [1, 8, 4, 0.3, 2], and paired with the corresponding outcome label (not shown, but for example, “0” representing failure, “1” represents success). The BMC maintains a training dataset comprising multiple such feature-vector/label pairs drawn from different boots and hardware states.

At step 320, the BMC trains a machine-learning model to correlate the transformed features with boot-success outcomes across a plurality of candidate PCIe bifurcation configurations. The training process consumes the feature vectors and outcome labels created at step 310 and learns parameters that map system conditions to predicted outcomes. The model type is not limited: as examples, the training may instantiate a decision-tree model 322or other supervised learners suited to tabular telemetry. The trained model is stored on the BMC for subsequent inference as described with respect to FIGS. 1 and 2.

In some embodiments, the training process illustrated in FIG. 3 may also encompass retraining. For instance, after one or more boot attempts, the BMC appends new system condition data—including slot occupancy, negotiated link widths, error records, thermal measurements, and the observed boot outcome—to the existing training dataset to obtain an augmented dataset. The feature-transformation pipeline at 310 is re-applied to the new records to produce additional feature vectors, and the training step 320 recomputes model parameters based on the augmented dataset. For models such as decision trees, retraining may adjust decision thresholds or modify feature splits. The resulting refreshed model is then used by the BMC during inference to generate updated recommendations for PCIe bifurcation configurations under newly observed conditions.

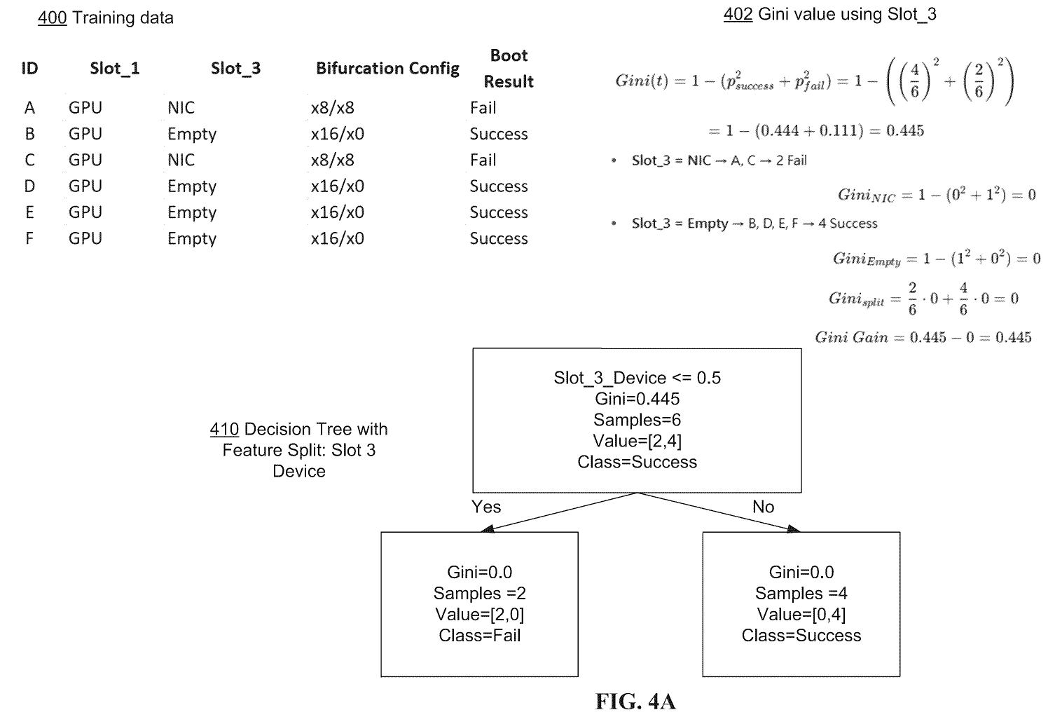

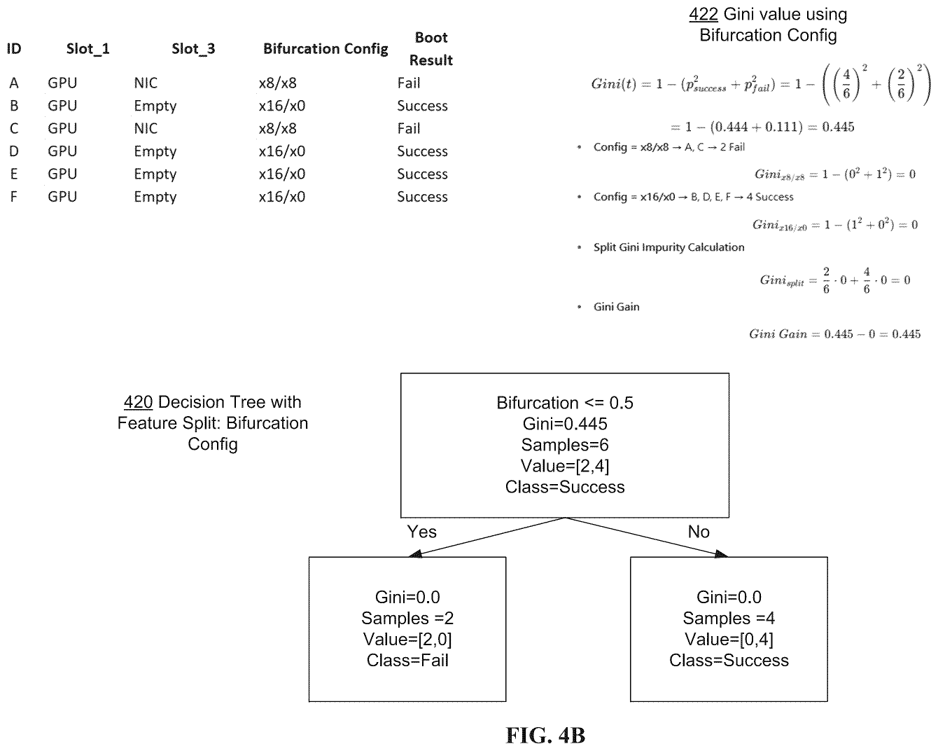

FIGS. 4A-4B illustrate example feature splits of a decision-tree model used to predict PCIe bifurcation outcomes, in accordance with some embodiments. In this example, the sample training dataset 400 include six records, where each record contains the device in Slot_1 (GPU in this example), the device in Slot_3 (NIC or Empty), the Bifurcation Config actually used (x8/x8 or x16/x0), and the observed Boot Result (Fail or Success). Categorical fields are encoded to numeric indicators for training; for example, “Slot_3 device” may be encoded as 1 for NIC and 0 for Empty, and “Bifurcation Config” may be encoded as 0 for x8/x8 and 1 for x16/x0. With two failures (A and C) and four successes (B, D, E, F), the root node has a Gini impurity of 0.445.

In some embodiments, during the training or construction of the decision tree, the “impurity” of a node is commonly measured using the Gini impurity metric. For a given node t, the Gini impurity may be defined as (formula 1):

$$Gini ( t ) = 1 - {\sum }_{i - 1}^{C} {p}_{i}^{2} \qquad ( 1 )$$

where C is the number of possible outcome classes at that node and pip_ipi is the fraction of samples belonging to class i. A node is considered “pure” (Gini=0) when all of its samples belong to a single class, and its impurity increases as the samples become more mixed across classes. When a candidate split divides the samples of a parent node into left and right child nodes, the quality of the split is evaluated by computing a weighted average of the child impurities (formula 2):

$$G i n {i}_{split} = \frac{{N}_{L}}{N} Gini ( {t}_{L} ) + \frac{{N}_{R}}{N} Gini ( {t}_{R} ) \qquad ( 2 )$$

where N_{L} and N_{R} are the sample counts in the left and right child nodes and N=N_{L}+N_{R} is the parent sample count. At each stage, the training algorithm selects the feature and threshold that minimize this weighted impurity, thereby maximizing the separation between classes (each leaf node has the smallest Gini, ideally 0 (purest)).

In FIG. 4A, using the sample training dataset 400, the decision tree 410 selects “Slot_3 device” as the first split because it gives the largest Gini reduction on that dataset. For illustration, assume the device code for NIC is a numeric value ≤0.5 and the code for Empty is >0.5. The split condition “Slot_3_Device≤0.5” therefore routes rows with Slot_3=NIC to the left child and rows with Slot_3=Empty to the right child. The left child contains two samples and both are Fail (Gini=0.0), whereas the right child contains four samples and all are Success (Gini=0.0). The root node's impurity is 0.445 (the computation process is illustrated in 402 using the formulas 1 and 2 described above), so this split perfectly separates outcomes in the toy data. If the dataset were different—for example, if GPU in Slot_3 (coded as 1) also tended to fail under x8/x8—the impurity of this “Slot_3 device” split would rise. In that case the training algorithm would compare impurity reductions across alternative thresholds and other features, and choose the split that yields the largest decrease instead of “Slot_3 device.”

In FIG. 4B, the tree 420 chooses the Bifurcation Config feature as the root split. With an encoding in which x8/x8≤0.5 and x16/x0>0.5, the condition “Bifurcation≤0.5” sends the two x8/x8 rows—both Fail—to the left child (Gini=0.0) and the four x16/x0 rows—all Success—to the right child (Gini=0.0). As in FIG. 4A, the parent node has Gini=0.445 and both children are pure (the computation process is illustrated in 422 using the formulas 1 and 2 described above). Taken together, FIGS. 4A-4B show that different features can provide the best first split on small datasets; in practice the decision-tree trainer selects, at each node, the feature and threshold that most reduce Gini impurity, and as the dataset grows (e.g., with retraining) the tree may introduce additional levels or change the chosen split to reflect the augmented evidence.

In some embodiments, after training, the constructed decision tree may be deployed for inferencing. Assume the current system condition encodes Slot_3=NIC. If only the decision tree 410 from FIG. 4A is deployed, the root split on “Slot_3 device” sends both candidates (x16/x0 and x8/x8) to the same left leaf that was trained entirely on failures. Both candidates therefore receive a failure prediction with high confidence. This is overconfident and inaccurate for x16/x0, because the training data did not actually contain the combination “NIC in Slot_3 under x16/x0.”

Conversely, if only the decision tree 420 from FIG. 4B is deployed, the root split on “Bifurcation Config” routes x8/x8 to the left failure leaf (which fits the data) and routes x16/x0 to the right success leaf. That right leaf is supported by four successes, but all of those rows had Slot_3=Empty. Treating x16/x0 as a high-confidence success is again overconfident, because the supporting samples do not cover the present “NIC in Slot_3” condition.

To correct these opposing, overconfident outcomes, some embodiments evaluate multiple decision trees or use a multi-layer decision tree structure so that different feature splits inform a combined decision. One example approach is to maintain two or more trees trained on the same feature schema but with different first-level splits (for example, tree 410 prioritizes “Slot_3 device” while tree 420 prioritizes “Bifurcation Config”) and to combine their outputs by voting or probability averaging with coverage-based weighting. In the above example, tree 410 votes “fail” for x16/x0 with high confidence, while tree 420 votes “success” for x16/x0 with high confidence; combining these conflicting high-confidence votes yields an overall “success” with low confidence because the system recognizes that neither tree's supporting leaf actually contains evidence for the specific combination “NIC in Slot_3+x16/x0.” Another approach is a deeper, multi-layer tree in which different layers enforce distinct feature splits (for instance, a top split on “Bifurcation Config” followed by a second split on “Slot_3 device”), and where leaves that lack matching historical coverage are automatically down-weighted to temper confidence.

Under either approach, x8/x8 remains a high-confidence failure (consistent with the data), while x16/x0 becomes a low-confidence success that better reflects the training corpus. The BMC can then rank x16/x0 over x8/x8 for the current boot but annotate the choice with a reduced confidence score and, if desired, store both the ranking and the attenuated confidence in the RMB for BIOS auditing and subsequent application at the next initialization.

In some embodiments, the decision tree(s) may be retrained or updated as new data arrive. For instance, after one or more boot attempts, the BMC appends new records—comprising slot occupancy, negotiated link widths, AER/CRC error counts, thermal measurements, and the observed boot outcome—to the training dataset, re-applies the encoding pipeline, and recomputes the model. Retraining may adjust decision thresholds or alter the selected feature splits when the augmented data indicate new patterns (for example, when a previously unseen device in Slot_3 changes the impurity landscape), thereby refining predictions used during subsequent inference.

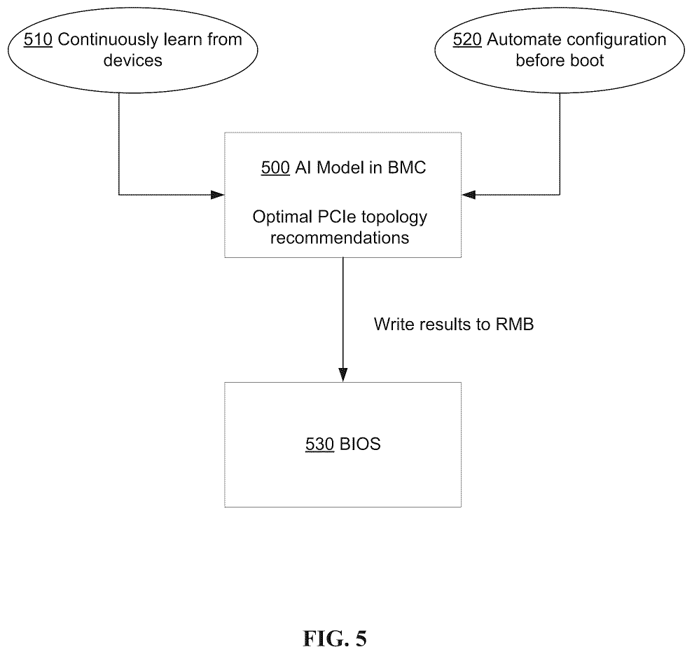

FIG. 5 illustrates an example inferencing phase of the machine learning model used to predict PCIe bifurcation outcomes, according to one example embodiment.

As shown in FIG. 5, the machine-learning model 500 executes on the BMC and receives system condition data that the BMC observes from the platform. As indicated by 510, the BMC monitors devices and environment and, in some embodiments, detects trigger events such as insertion or removal of a PCIe device, rising AER/CRC error rates, or exceeding a thermal threshold. In response to such a trigger, or on an administrative request, the BMC collects the current device presence/type per slot, negotiated link widths, recent error statistics, thermal readings and threshold-violation flags, slot-change or hot-plug activity, and the latest recorded boot outcomes, and encodes these values into the feature vector schema used by the model.

Using the features gathered at 510, the BMC applies the model 500 to evaluate a plurality of candidate PCIe bifurcation configurations prior to boot, as depicted by 520. For each candidate (e.g., x16/x0, x8/x8, x4/x4/x8), the model 500 outputs a predicted boot-success outcome or likelihood conditioned on the current system state. The BMC then ranks the candidates based on those predictions, selects a preferred configuration for the upcoming initialization, and, when the present hardware combination has not been seen before, the model 500 generates new entries so that the table captures the previously unseen device layout together with the candidate configurations and their scores.

In some embodiments, the selected configuration and the associated ranking are materialized by the BMC as a BIOS-readable bifurcation table and written into the reserved memory buffer 124. The table may include per-slot lane modes, a signature and version, a checksum for integrity, and optional annotations such as confidence scores and the ordered list of candidates. The BIOS 530 monitors the RMB 124 for updates, validates the table (e.g., via an SMI handler), and, upon successful validation, persists the preferred configuration—and optionally the ranked list—into a non-volatile region of the BIOS flash, such as a ROM hole, so that the configuration survives power loss and is available across reboots.

During the subsequent system initialization, the BIOS 530 retrieves the validated configuration from non-volatile storage and applies it to initialize PCIe links. If validation fails or no update is present, the BIOS 530 may fall back to the last known-good configuration already stored in the non-volatile region. The feedback from the resulting boot outcome is then recorded by the BMC and can be used to further refine or retrain the model 500, closing the loop between continuous observation (510), automated pre-boot configuration (520), RMB staging, BIOS application, and non-volatile persistence.

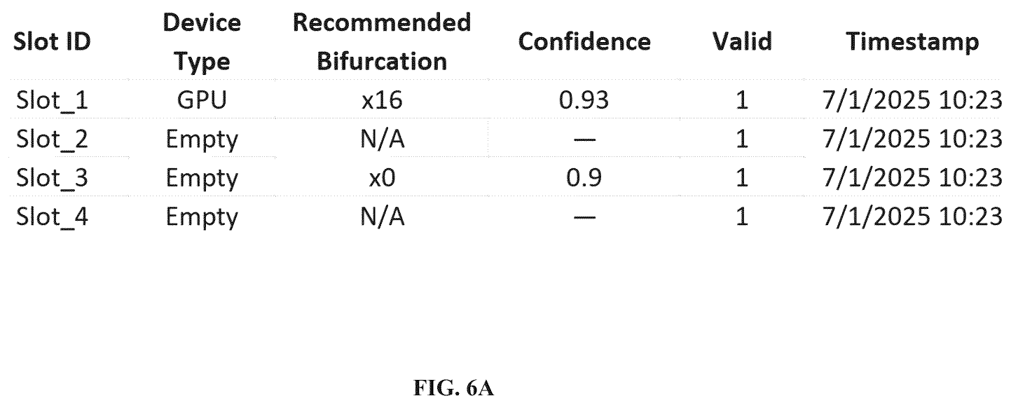

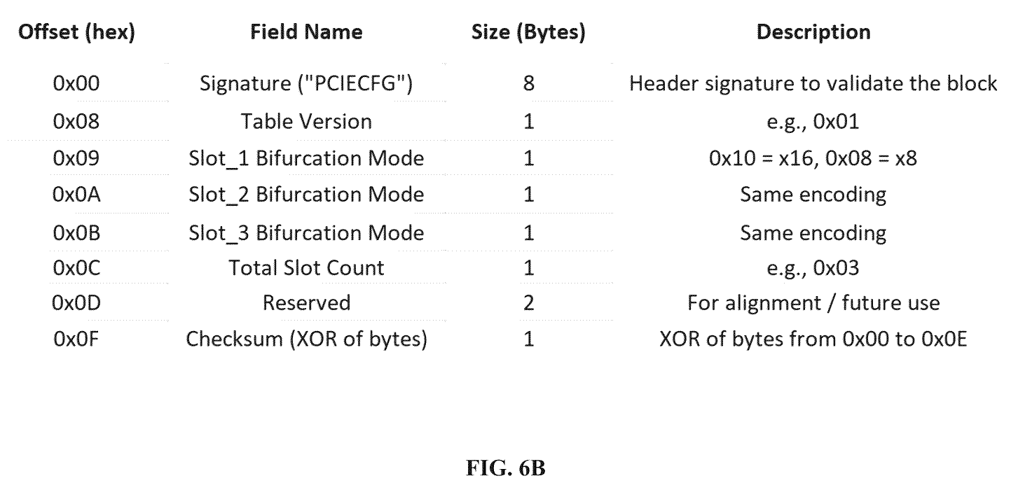

FIG. 6A illustrates an example inference result table generated by the machine learning model on the BMC, according to one example embodiment. In the depicted embodiment, the machine-learning model executed by the BMC produces, for each slot, a recommended PCIe lane mode together with auxiliary metadata. The table in FIG. 6A lists the Slot ID, the detected Device Type for that slot, the Recommended Bifurcation (for example, “x16” for Slot_1 and “x0” for Slot_3 in the illustrated state), a numeric Confidence that reflects the model's predicted likelihood of boot success under the recommendation, a Valid flag indicating that the recommendation passes policy and sanity checks, and a Timestamp used for ordering, auditing, and incremental updates. Empty slots may carry “N/A” for the recommendation and omit confidence, while populated slots are annotated with calibrated confidence values derived from the model's leaf statistics or ensemble vote weights. Where implemented, the BMC may also maintain a ranked list per slot or per root complex consistent with the claims, but the essential output is the per-slot recommended lane mode with confidence and validity indicators.

FIG. 6B illustrates an example data structure of a bifurcation configuration table stored in a reserved memory buffer (RMB), according to one example embodiment. In this figure, the example data structure begins at offset 0x00 with a header signature (e.g., “PCIECFG”) that allows the BIOS to recognize and validate the block, followed by a Table Version at 0x08. Per-slot lane-mode fields are then serialized—Slot_1 Bifurcation Mode at 0x09, Slot_2 Bifurcation Mode at 0x0A, Slot_3 Bifurcation Mode at 0x0B, and so on-using a compact encoding (for example, 0x10 to denote x16, 0x08 to denote x8). A Total Slot Count at 0x0C enables bounds checking, and two Reserved bytes at 0x0D-0x0E provide alignment and forward-compatibility. At 0x0F, a Checksum field stores an integrity value, such as the XOR of all prior bytes in the block, that the BIOS verifies before accepting the table.

The relationship between the example data structures in FIGS. 6A and 6B is the transformation from model-level recommendations to firmware-level configuration. The BMC first produces the human-readable inference table of FIG. 6A, which captures device context, recommended lane splits, confidence, and timing. The BMC then materializes those recommendations into the compact binary structure of FIG. 6B by mapping the “Recommended Bifurcation” entries to the corresponding per-slot mode bytes, setting the version and slot count, optionally embedding a validity bitmap or epoch in the reserved area, and computing the checksum. The resulting structure is written into the RMB for BIOS consumption. Upon detecting the update, the BIOS parses the FIG. 6B block, verifies the signature and checksum, and applies the encoded lane modes during the next initialization, while the richer FIG. 6A information (including confidence and timestamps) can be retained by the BMC for audit trails, ranking persistence, or incremental update generation.

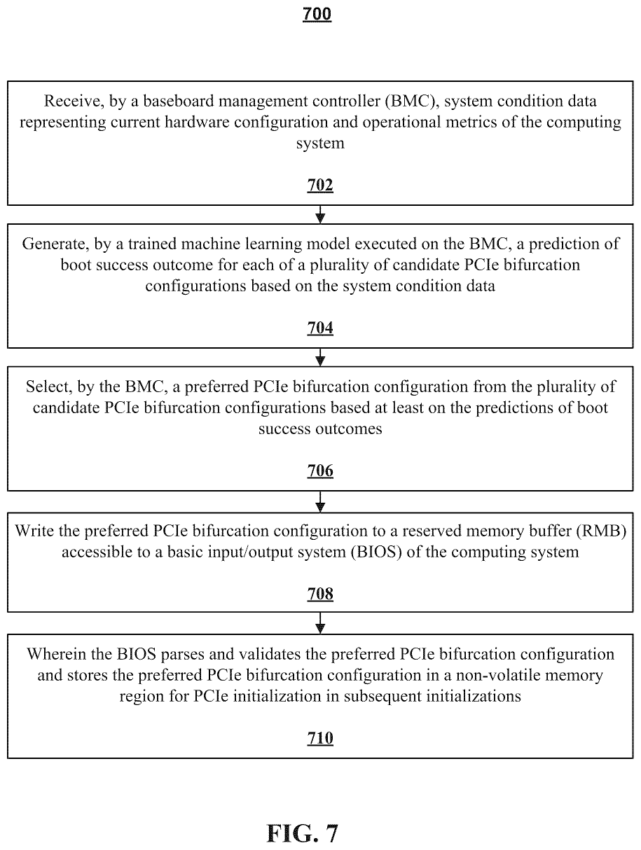

FIG. 7 is a flowchart of an example process 700. In some implementations, one or more blocks of process 700 are performed by a computing device. As shown in FIG. 7, at block 702 the process includes receiving, by a baseboard management controller (BMC), system-condition data representing the current hardware configuration and operational metrics of the computing system. At block 704, the process includes generating, by a trained machine-learning model executed on the BMC, a prediction of boot-success outcome for each of a plurality of candidate PCIe bifurcation configurations based on the system-condition data. At block 706, the BMC selects a preferred PCIe bifurcation configuration from among the candidates based at least on the predicted boot-success outcomes. At block 708, the BMC writes the preferred configuration to a reserved memory buffer (RMB) accessible to the basic input/output system (BIOS). At block 710, the BIOS parses and validates the preferred configuration and stores it in a non-volatile memory region so that, during subsequent initializations, the BIOS can retrieve the stored configuration and apply it to initialize PCIe links.

Process 700 may be used with additional implementations, either individually or in any combination with one another and/or with other processes described herein. In a first implementation, the system-condition data includes at least one of: PCIe device presence or type in individual slots; negotiated link width; error metrics including counts of Advanced Error Reporting (AER) errors or cyclic redundancy check (CRC) errors; thermal measurements; detection of threshold violations; slot-usage frequency or hot-plug events; and boot outcomes recorded across prior initialization cycles.

In a second implementation, alone or in combination with the first implementation, process 700 further includes training the machine-learning model. Training includes: collecting or receiving historical system-condition data from a plurality of prior boot attempts, the historical data including one or more of PCIe logs, negotiated link widths, link-training logs, error records, and boot outcomes; transforming the historical data into feature vectors with associated outcome labels; and training the machine-learning model based on the feature vectors and outcome labels to correlate the historical data with boot-success outcomes of the plurality of candidate PCIe bifurcation configurations.

In a third implementation, alone or in combination with the first and second implementations, the machine-learning model comprises a decision tree, and training includes: applying the feature vectors to the decision tree as inputs, wherein the decision tree partitions the feature space using a Gini-impurity criterion to identify one or more feature splits most correlated with the boot outcomes; and storing the trained decision-tree model in the BMC for use in generating predictions of boot-success outcomes for the plurality of candidate PCIe bifurcation configurations during inference.

In a fourth implementation, alone or in combination with one or more of the first through third implementations, process 700 further includes periodically retraining the machine-learning model. Retraining includes: appending, after one or more boot attempts, new system-condition data—such as slot occupancy, negotiated link widths, error records, thermal measurements, and boot outcome—to a training dataset maintained by the BMC, thereby obtaining an augmented dataset; and recomputing decision thresholds or changing one or more feature splits of the model based on the augmented dataset.

In a fifth implementation, alone or in combination with one or more of the first through fourth implementations, storing the preferred PCIe bifurcation configuration in the RMB includes writing the preferred configuration to a bifurcation table with checksum data for integrity validation.

In a sixth implementation, alone or in combination with one or more of the first through fifth implementations, the trained machine-learning model comprises a decision tree, and generating the prediction of boot-success outcome includes: applying current system-condition feature vectors to the decision tree; traversing the decision tree along feature splits previously determined during training using a Gini-impurity criterion; and outputting, based on the reached leaf nodes, the predicted boot-success outcomes for the plurality of candidate PCIe bifurcation configurations corresponding to the current feature vectors.

In a seventh implementation, alone or in combination with one or more of the first through sixth implementations, receiving the system-condition data includes detecting a trigger event comprising one or more of insertion of a new PCIe device, removal of a PCIe device, rising PCIe error rates, or exceeding a thermal threshold, and collecting the system-condition data in response to detecting the trigger event.

In an eighth implementation, alone or in combination with one or more of the first through seventh implementations, process 700 further includes writing the preferred PCIe bifurcation configuration into a non-volatile memory region accessible across power cycles.

In a ninth implementation, alone or in combination with one or more of the first through eighth implementations, process 700 further includes ranking the plurality of candidate PCIe bifurcation configurations by their corresponding predicted boot-success outcomes and storing the ranked list in the RMB.

In a tenth implementation, alone or in combination with one or more of the first through ninth implementations, the machine-learning model is configured to generate new entries when a hardware combination not previously observed is detected.

Although FIG. 7 shows example blocks of process 700, in some implementations process 700 may include additional, fewer, different, or differently arranged blocks than those depicted in FIG. 7. Additionally, two or more blocks of process 700 may be performed in parallel.

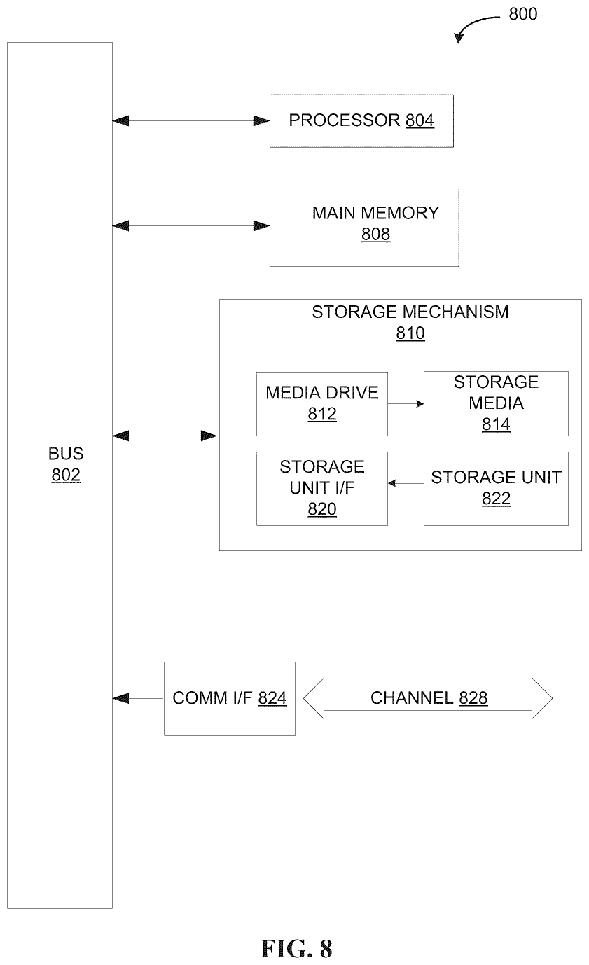

FIG. 8 illustrates an example computing system 800 that may be used in implementing various features of embodiments of the disclosed technology.

As used herein, the term module might describe a given unit of functionality that can be performed in accordance with one or more embodiments of the present application. As used herein, a module might be implemented utilizing any form of hardware, software, or a combination thereof. For example, one or more processors, controllers, ASICs, PLAS, PALS, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the application are implemented in whole or in part using software, in one embodiment, these software elements can be implemented to operate with a computing or processing module capable of carrying out the functionality described with respect thereto. One such example computing module is shown in FIG. 8. Various embodiments are described in terms of this example-computing module 800. After reading this description, it will become apparent to a person skilled in the relevant art how to implement the application using other computing modules or architectures.

Referring now to FIG. 8, computing module 800 may represent, for example, computing or processing capabilities found within desktop, laptop, notebook, tablet, cloud and edge, computers; hand-held computing devices (tablets, PDA's, smart phones, cell phones, palmtops, etc.); mainframes, supercomputers, workstations or servers; or any other type of special-purpose or general-purpose computing devices as may be desirable or appropriate for a given application or environment. Computing module 800 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 800 might include, for example, one or more processors, controllers, control modules, or other processing devices, such as a processor 804. Processor 804 might be implemented using a general-purpose or special-purpose processing engine such as, for example, a microprocessor, controller, or other control logic. In the illustrated example, processor 804 is connected to a bus 802, although any communication medium can be used to facilitate interaction with other components of computing module 800 or to communicate externally. The bus 802 may also be connected to other components such as a display, input devices, or cursor control to help facilitate interaction and communications between the processor and/or other components of the computing module 800.

Computing module 800 might also include one or more memory modules, simply referred to herein as main memory 808. For example, preferably random-access memory (RAM) or other dynamic memory might be used for storing information and instructions to be executed by processor 804. Main memory 808 might also be used for storing temporary variables or other intermediate information during execution of instructions to be executed by processor 804. Computing module 800 might likewise include a read only memory (“ROM”) or other static storage device 810 coupled to bus 802 for storing static information and instructions for processor 804.

Computing module 800 might also include one or more various forms of information storage devices 810, which might include, for example, a media drive 812 and a storage unit interface 820. The media drive 812 might include a drive or other mechanism to support fixed or removable storage media 814. For example, a hard disk drive, a floppy disk drive, a magnetic tape drive, an optical disk drive, a CD, DVD or Bluray drive (R or RW), or other removable or fixed media drive 812 might be provided. Accordingly, storage media 814 might include, for example, a hard disk, a floppy disk, magnetic tape, cartridge, optical disk, a CD or DVD, or other fixed or removable medium that is read by, written to or accessed by media drive 812. As these examples illustrate, the storage media 814 can include a computer usable storage medium having stored therein computer software or data.

In alternative embodiments, information storage devices 810 might include other similar instrumentalities for allowing computer programs or other instructions or data to be loaded into computing module 800. Such instrumentalities might include, for example, a fixed or removable storage unit 822 and a storage unit interface 820. Examples of such storage units and storage unit interfaces can include a program cartridge and cartridge interface, a removable memory (for example, a flash memory or other removable memory module) and memory slot, a PCMCIA slot and card, and other fixed or removable storage units and interfaces that allow software and data to be transferred from the storage unit to computing module 800.

Computing module 800 might also include a communications interface 824 or network interface(s). Communications or network interface(s) interface 824 might be used to allow software and data to be transferred between computing module 800 and external devices. Examples of communications interface or network interface(s) might include a modem or soft modem, a network interface (such as an Ethernet, network interface card, WiMedia, WiFi, IEEE 802.XX or other interface), a communications port (such as for example, a USB port, IR port, RS232 port Bluetooth® interface, or other port), or other communications interface. Software and data transferred via communications or network interface(s) might typically be carried on signals, which can be electronic, electromagnetic (which includes optical) or other signals capable of being exchanged by a given communications interface. These signals might be provided to communications interface via a channel 828. This channel might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media such as, for example, memory 808, ROM, and storage unit interface 820. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 800 to perform features or functions of the present application as discussed herein.

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Each process, method, and algorithm described in the preceding sections may be embodied in, and fully or partially automated by, code modules executed by one or more computer systems or computer processors comprising computer hardware. The processes and algorithms may be implemented partially or wholly in application-specific circuitry.

When the functions disclosed herein are implemented in the form of software functional units and sold or used as independent products, they can be stored in a processor executable non-volatile computer readable storage medium. Particular technical solutions disclosed herein (in whole or in part) or aspects that contribute to current technologies may be embodied in the form of a software product. The software product may be stored in a storage medium, comprising a number of instructions to cause a computing device (which may be a personal computer, a server, a network device, and the like) to execute all or some steps of the methods of the embodiments of the present application. The storage medium may comprise a flash drive, a portable hard drive, ROM, RAM, a magnetic disk, an optical disc, another medium operable to store program code, or any combination thereof.

Particular embodiments further provide a system comprising a processor and a non-transitory computer-readable storage medium storing instructions executable by the processor to cause the system to perform operations corresponding to steps in any method of the embodiments disclosed above. Particular embodiments further provide a non-transitory computer-readable storage medium configured with instructions executable by one or more processors to cause the one or more processors to perform operations corresponding to steps in any method of the embodiments disclosed above.

Embodiments disclosed herein may be implemented through a cloud platform, a server or a server group (hereinafter collectively the “service system”) that interacts with a client. The client may be a terminal device, or a client registered by a user at a platform, wherein the terminal device may be a mobile terminal, a personal computer (PC), and any device that may be installed with a platform application program.

The various features and processes described above may be used independently of one another or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The exemplary systems and components described herein may be configured differently than described. For example, elements may be added to, removed from, or rearranged compared to the disclosed example embodiments.

The various operations of exemplary methods described herein may be performed, at least partially, by an algorithm. The algorithm may be comprised in program codes or instructions stored in a memory (e.g., a non-transitory computer-readable storage medium described above). Such an algorithm may comprise a machine learning algorithm. In some embodiments, a machine learning algorithm may not explicitly program computers to perform a function but can learn from training data to make a prediction model that performs the function.

The various operations of exemplary methods described herein may be performed, at least partially, by one or more processors that are temporarily configured (e.g., by software) or permanently configured to perform the relevant operations. Whether temporarily or permanently configured, such processors may constitute processor-implemented engines that operate to perform one or more operations or functions described herein.

Similarly, the methods described herein may be at least partially processor-implemented, with a particular processor or processors being an example of hardware. For example, at least some of the operations of a method may be performed by one or more processors or processor-implemented engines. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the subject matter has been described with reference to specific example embodiments, various modifications and changes may be made to these embodiments without departing from the broader scope of embodiments of the present disclosure. Such embodiments of the subject matter may be referred to herein, individually or collectively, by the term “invention” merely for convenience and without intending to voluntarily limit the scope of this application to any single disclosure or concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art.

As used herein, “or” is inclusive and not exclusive, unless expressly indicated otherwise or indicated otherwise by context. Therefore, herein, “A, B, or C” means “A, B, C, A and B, A and C, B and C, or A, B, and C,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context. Moreover, plural instances may be provided for resources, operations, or structures described herein as a single instance. Additionally, boundaries between various resources, operations, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

The term “include” or “comprise” is used to indicate the existence of the subsequently declared features, but it does not exclude the addition of other features. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

What is claimed is:

1. A computer-implemented method for configuring Peripheral Component Interconnect Express (PCIe) bifurcation in a computing system, the method comprising:
receiving, by a baseboard management controller (BMC), system condition data representing current hardware configuration and operational metrics of the computing system;
generating, by a trained machine learning model executed on the BMC, a prediction of boot success outcome for each of a plurality of candidate PCIe bifurcation configurations based on the system condition data;
selecting, by the BMC, a preferred PCIe bifurcation configuration from the plurality of candidate PCIe bifurcation configurations based at least on the predictions of boot success outcomes; and
writing the preferred PCIe bifurcation configuration to a reserved memory buffer (RMB) accessible to a basic input/output system (BIOS) of the computing system,
wherein the BIOS parses and validates the preferred PCIe bifurcation configuration and stores the preferred PCIe bifurcation configuration in a non-volatile memory region for PCIe initialization in subsequent initializations.

2. The method of claim 1, wherein the system condition data comprises at least one of:
PCIe device presence in individual slots;
PCIe device types in individual slots;
negotiated link width;
error metrics comprising counts of Advanced Error Reporting (AER) errors or cyclic redundancy check (CRC) errors;
thermal measurements;
detection of threshold violations;
slot usage frequency or hot-plug events; and
boot outcomes recorded across prior initialization cycles.

3. The method of claim 1, further comprising training the machine learning model, wherein the training comprises:
collecting or receiving historical system condition data from a plurality of prior boot attempts, the historical system condition data comprising one or more of PCIe logs, negotiated link widths, link training logs, error records, and boot outcomes;
transforming the historical system condition data into feature vectors with associated outcome labels; and
training the machine learning model based on the feature vectors and outcome labels to correlate the historical system condition data with boot success outcomes of the plurality of candidate PCIe bifurcation configurations.

4. The method of claim 3, wherein the machine learning model comprises a decision tree, and the training comprises:
applying the feature vectors to the decision tree as inputs, wherein the decision tree partitions a feature space of the feature vectors using a Gini impurity criterion to identify one or more feature splits most correlated with the boot outcomes; and
storing the trained decision tree model in the BMC for use in generating the prediction of the boot success outcomes of the plurality of candidate PCIe bifurcation configurations during inference.

5. The method of claim 1, further comprising retraining the machine learning model periodically, wherein the retraining comprises:
appending, after one or more boot attempts, new system condition data comprising slot occupancy, negotiated link widths, error records, thermal measurements, and boot outcome to a training dataset maintained by the BMC, thereby obtaining an augmented training dataset; and
recomputing decision thresholds or changing one or more feature splits of the machine learning model based on the augmented training dataset.

6. The method of claim 1, wherein storing the preferred PCIe bifurcation configuration in the RMB comprises:
writing the preferred PCIe bifurcation configuration to a bifurcation table with checksum data for integrity validation.

7. The method of claim 1, wherein the trained machine learning model comprises a decision tree, and generating the prediction of boot success outcome comprises:
applying current system condition feature vectors representing the system condition data to the decision tree;
traversing the decision tree along feature splits previously determined during training using a Gini impurity criterion; and
outputting, based on leaf nodes reached in the decision tree, the predicted boot success outcomes for the plurality of candidate PCIe bifurcation configurations corresponding to the current system condition feature vectors.

8. The method of claim 1, wherein the receiving system condition data comprises:
detecting a trigger event comprising one or more of insertion of a new PCIe device, removal of a PCIe device, rising PCIe error rates, or exceeding a thermal threshold; and
collecting the system condition data in response to detecting the trigger event.

9. The method of claim 1, further comprising:
writing the preferred PCIe bifurcation configuration into a non-volatile memory region accessible across power cycles.

10. The method of claim 1, further comprising:
ranking the plurality of candidate PCIe bifurcation configurations by corresponding outcomes of boot success and storing the ranked list in the RMB.

11. The method of claim 1, wherein the machine learning model is configured to generate new entries when a hardware combination not previously observed is detected.

12. A computing system for dynamically configuring PCI Express (PCIe) bifurcation settings, the system comprising:
a baseboard management controller (BMC) configured to:
receive system condition data indicative of current hardware configuration and operational metrics;
execute a machine learning model trained to predict boot outcomes for different PCIe bifurcation configurations;
determine, based on the predicted boot outcomes, a preferred PCIe bifurcation configuration; and
write the preferred PCIe bifurcation configuration in a reserved memory buffer (RMB); and
a basic input/output system (BIOS) configured to:
in response to detecting the preferred PCIe bifurcation configuration in the RMB, parse and validate the preferred PCIe bifurcation configuration;
write the valid preferred PCIe bifurcation configuration in a non-volatile memory region associated with the BIOS; and
during a subsequent initialization of the computing system, retrieve the persisted configuration and apply the configuration to initialize PCIe links.

13. The computing system of claim 12, wherein the system condition data comprises at least one of:
PCIe device presence in individual slots;
PCIe device types in individual slots;
negotiated link width;
error metrics including counts of Advanced Error Reporting (AER) errors or cyclic redundancy check (CRC) errors;
thermal measurements;
detection of threshold violations;
slot usage frequency or hot-plug events; and
historical boot outcomes recorded across prior initialization cycles.

14. The computing system of claim 12, wherein the machine learning model comprises a decision tree, and to execute the decision tree to predict the boot outcomes, the BMC is further configured to:
apply current system condition feature vectors as inputs to the decision tree;
traverse the decision tree along previously learned feature splits, the feature splits having been identified during training using a impurity criterion; and
output, based on leaf nodes reached in the decision tree, predicted boot success outcomes for a plurality of candidate PCIe bifurcation configurations for the current system condition feature vectors.

15. The computing system of claim 12, wherein the machine learning model is configured to generate new entries when a hardware combination not previously observed is detected.

16. A non-transitory computer-readable storage medium storing instructions that, when executed by a baseboard management controller (BMC), cause the BMC to perform operations comprising:
receiving system condition data from a plurality of PCIe slots;
applying the system condition data to a trained machine learning model to obtain predicted boot outcomes for a plurality of candidate PCIe bifurcation configurations;
selecting a preferred bifurcation configuration based on the predicted boot outcomes;
storing the preferred bifurcation configuration in a reserved memory buffer (RMB) accessible to a BIOS for validation; and
storing the valid preferred bifurcation configuration into a non-volatile memory region for subsequent use in PCIe initialization.

17. The non-transitory computer-readable storage medium of claim 16, wherein the system condition data comprises at least one of:
PCIe device presence or type in individual slots;
negotiated link width;
error metrics including counts of Advanced Error Reporting (AER) errors or cyclic redundancy check (CRC) errors;
thermal measurements;
detection of threshold violations;
slot usage frequency or hot-plug events; and
historical boot outcomes recorded across prior initialization cycles.

18. The non-transitory computer-readable storage medium of claim 16, wherein the trained machine learning model comprises a decision tree, and generating the prediction of boot success outcome comprises:
applying current system condition feature vectors representing the system condition data to the decision tree;
traversing the decision tree along feature splits previously determined during training using an impurity criterion; and
outputting, based on leaf nodes reached in the decision tree, the predicted boot success outcomes for the plurality of candidate PCIe bifurcation configurations corresponding to the current system condition feature vectors.

19. The non-transitory computer-readable storage medium of claim 16, wherein the receiving system condition data comprises:
detecting a trigger event comprising one or more of insertion of a new PCIe device, removal of a PCIe device, rising PCIe error rates, or exceeding a thermal threshold; and
collecting the system condition data in response to detecting the trigger event.

20. The non-transitory computer-readable storage medium of claim 16, wherein the operations further comprise training the machine learning model, wherein the training comprises:
collecting or receiving historical system condition data from a plurality of prior boot attempts, the historical system condition data comprising one or more of PCIe logs, negotiated link widths, link training logs, error records, and boot outcomes;
transforming the historical system condition data into feature vectors with associated outcome labels; and
training the machine learning model based on the feature vectors and outcome labels to correlate the historical system condition data with boot success outcomes of the plurality of candidate PCIe bifurcation configurations.
